(19) United States
(12) Patent Application Publication
(10) Pub. No.: US 2013/0117143 A1
(43) Pub. Date: May 9, 2013

(54) Systems and Methods for Conducting Sales of Third Parties Through Bidding

(71) Applicant: EGAINERS LLC, Miami, FL (US)

(72) Inventors: Massimo Colella, North Bay Village, FL (US); Joseph Victor Behar, Miami Beach, FL (US)

(73) Assignee: EGAINERS LLC, Miami, FL (US)

(21) Appl. No.: 13/670,556

(22) Filed: Nov. 7, 2012

Related U.S. Application Data
(60) Provisional application No. 61/556,531, filed on Nov. 7, 2011.

(51) Int. Cl. G06Q 30/08

(52) U.S. Cl. 705/26.3

(57) ABSTRACT

Provided are systems and methods for selling an item using a host. An event is created for the item. The event can be configured as a virtual envelope. Rules are set for the event. The rules can be a reserve amount, bidding rules, bidder rules, a time limit, and seller profit rules. Bidders are allowed to post on the virtual envelope in order to make bids on the item. The item is sold based on the rules for the event.

### CROSS-REFERENCE TO RELATED APPLICATIONS

This application claims priority to U.S. Provisional Application Ser. No. 61/556,531, filed on Nov. 7, 2011, the entire disclosure of which is hereby incorporated herein by reference in its entirety.

### STATEMENT REGARDING FEDERALLY SPONSORED RESEARCH OR DEVELOPMENT

Not Applicable

### FIELD OF THE INVENTION

The present invention lies in the field of conducting sales of goods and services of third parties through bidding. The present disclosure relates to systems and methods of using bids (obtained by selling products, purchasing them or getting them in referring friends or subscriptions to the platform, etc.) that allow the winning bidder the ability to secure the offered product for free or that allow the seller to receive the value of some or all of the money bid by the non-winning bidder(s) that can even be significantly more money than the actual value of the product being sold. Non-Winning bidders may be able to recover their bids, and use them to buy similar products on sales by other sellers.

### BACKGROUND OF THE INVENTION

Many companies exist who auction used and/or new items. These companies range from auction houses such as Sotheby's, for example, which started in 1744, to Internet-based sellers such as EBay.

There currently are companies commonly called PennyAuctions that allow customers to buy for a price a number of bids and allow those bids to be used toward purchasing a product allegedly at a discount. Quibids (at www.quibids.com) is one such company.

These prior existing systems occur live (in person) or electronically (over the Internet, over telecommunication devices, over email). None of these allow the winning bidder the ability to secure the offered product supplied by third-parties (market place), which may be new or used, for free. Nor do they allow the seller to receive the value of some or all of the money bid by the non-winning bidder(s) that can be significantly more money than the actual value of the product being sold.

Thus, a need exists to overcome the problems with the prior art systems, designs, and processes as discussed above.

### SUMMARY OF THE INVENTION

The invention provides systems and methods for conducting sales of goods or services through bidding that overcome the hereinafore-mentioned disadvantages of the heretofore-known devices and methods of this general type and that provide such features to allow a winning bidder the ability to secure the offered product by third parties (e.g., the market place) for free and/or to allow the seller to receive the value of some or all of the money bid by the non-winning bidder(s), which value can even be significantly more money than the actual value of the product being sold. The non-winning bidders may be allowed to recover their bids and apply them toward buying similar products from other sellers willing to sell.

With the foregoing and other objects in view, there is provided, in accordance with the invention, systems and methods for selling an item using a host. An event is created for the item. The event can be configured as a virtual envelope. Rules are set for the event. The rules can be a reserve amount, bidding rules, bidder rules, a time limit, and seller profit rules. Bidders are allowed to post on the virtual envelope in order to make bids on the item. The item is sold based on the rules for the event.

In accordance with a further mode of the invention, the reserve amount is a minimum of a total of the bids made by all non-winning bidders.

In accordance with added modes of the invention, the bids can be refundable, non-refundable, or increased.

In accordance with an additional mode of the invention, a seller may select at least one or both of a minimum and a maximum number of bidders for the event.

In accordance with yet another mode of the invention, a seller may allow bidders to know the reserve amount.

In accordance with yet a further mode of the invention, the seller can see a number of bidders and a total amount of bids.

In accordance with yet an added mode of the invention, lower already purchased bids are used as a credit toward higher costing bids.

In accordance with yet an additional mode of the invention, bids are received over the Internet. Bids can be received through email. Bids can be received through an application on a communication device.

In accordance with again another mode of the invention, bids are received from a communication device.

In accordance with again a further mode of the invention, bids are deemed as at least one of non-refundable deposits and options to buy.

In accordance with again an added mode of the invention, a winning bidder wins the item and the winning bidder's bid is at least partially refunded. A bid amount not refunded to the winning bidder may be paid to the seller subject to a fee for the host.

In accordance with again an additional mode of the invention, a seller may have the right to cancel the event, e.g., within rules for cancellation.

In accordance with still another mode of the invention, at least a portion of the bids is credited to the bidders.

In accordance with a concomitant feature of the invention, a seller allows each bidder to know where the bids are ranked.

Although the invention is illustrated and described herein as embodied in methods and systems for conducting sales of goods and services through bidding, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a flow diagram depicting one exemplary embodiment of a process of the present invention;

FIG. 2 is a block circuit diagram of an exemplary embodiment of a system for hosting the process of the present invention; and

FIG. 3 is a block circuit diagram of an exemplary embodiment of a system for using the process of the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” and the like as used herein, are defined as a sequence of instructions designed for execution on a computer system. A “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

The business principle of the current invention is referred to as “eGainers” and is a bidding system used to win products offered for “sale” by members of the public. Even though the invention describes use of individuals as the “sellers,” it is not limited thereto and legal entities such as businesses can be sellers as well. Anyone can be a bidder to bid on the product being offered.

eGainers is a platform where sellers offer their products on which buyers bid to win. In the invention, the seller, for the first time, has the ability to receive much more money than what could have been received for the product in a straight sale between a single buyer and a single seller. In exemplary embodiments, the product is offered for receiving bids in particular events over the Internet, e.g., through email, or through communication devices such as phones (including apps on those devices). The events are each configured as a virtual “envelope” for the purpose of allowing bidders to “enter” the “envelope” to participate in the respective bidding event. Each “envelope” has particularized rules, including a minimum bid, the type of product, and a minimum and/or maximum number of bidders who may “post” on the “envelope” to make bids. The rules are pre-defined by the host platform (i.e., eGainers) and are presented to the seller for selection when setting up the bidding event.

In the eGainers system, bids are deemed as non-refundable deposits and/or options to buy, depending on the deposit/option rules of the particular event. Sellers may establish a reserve price amount, depending on the reserve rules of that particular event. The reserve is the minimum of the total bids made by all non-winning bidders for the product being offered. The events may be limited by time, depending on the particular time rules for that event. The deal could be ON or OFF depending on these rules. In various embodiments, the bidders may or may not know any identifying information of other bidders and the amount of the bids of the other bidders may be kept secret as well, depending on the bidder viewing rules of the particular event. Sellers, on the other hand, may have access to see all or some bids and the total amounts of the bids during the course of the bidding. Bidders may or may not be aware of the sellers' reserve price, again, depending on the bid viewing rules for the particular event. Bidders are able to bid an amount that may require a minimum number of bids, depending on the bidder number rules of the particular event. There may be a minimum and/or a maximum number of bidders required merely to enter the event, for example. In each instance, the non-winning bidder(s) will lose all or some of their bid at the end of the event, depending on the loss rules for the particular event. The winning bidder wins the product and the winner's bid is fully or partially refunded, depending on the refund rules for the particular event. All of the money collected during the event that is not returned to the winning bidder is paid directly to the seller through the host, i.e., eGainers, with the host retaining a fee depending on the rules selected by the seller and/or from the website for that particular event. Each rule selected will determine if the percentage to the host increases or decreases. The non-winning bidders may or may not have the option to recover their bids in order to buy similar products for sale by other sellers in the market place.

Another option for the seller lies in having an option to sell, as opposed to a forced sale in every case. More specifically, if the reserve price is not met by the bidders entering the event, the deal is OFF and the seller has the right to cancel, e.g., refuse to accept, the entire transaction and, in such a case, some or all of the bids are refunded to the bidders. The amount refunded, if any, will depend on the particular seller opt-out rules of that particular event. On the other hand, if the reserve amount or price is met or exceeded, the deal is ON and the seller is required to accept the transaction and will receive money collected from the bids following the website rules and conditions. This total includes all the money associated with the bids of the non-winning bidders minus eGainers' host fee. According to the rules of delivery established by eGainers, the seller delivers the product to the winning bidder. The cost for delivery could be included in the bids or it could be something that the winning bidder or the seller pay or divide amongst themselves.

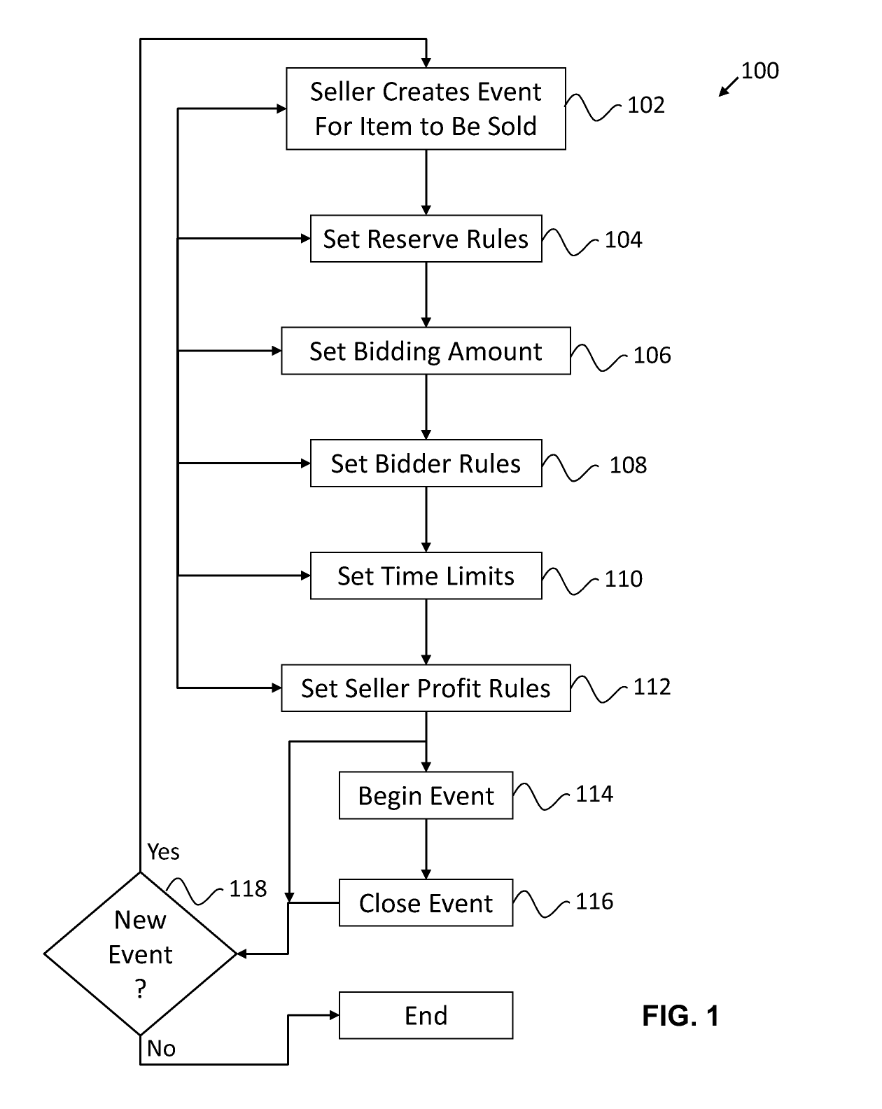

Described now are exemplary embodiments of the present invention. Referring now to the figures of the drawings in detail and first, particularly to the flow chart of FIG. 1, there is illustrated a first exemplary embodiment of a bidding process 100 according to the invention. In this exemplary embodiment, a seller desires to sell an item, which can be used or new.

The seller creates an event, in step 102, by entering a description of the item to be sold. The rules for the event are then determined. In step 104, the seller sets the reserve rules to establish a reserve price amount. The reserve is the minimum of the total bids made by all non-winning bidders for the product being sold. In step 106, the seller decides on a minimum bid amount. This means that any bidder who is interested in joining the event must have already on hand a bid that is equal or higher of the minimum bid amount. Importantly, bids may or may not be refundable. While bids cannot be decreased, they may be increased, for example, by purchasing additions so that the lower already purchased bids can be used as a credit towards higher-costing bids. In step 108, the seller selects various rules relating to the bidders. For example, the seller selects a minimum and/or maximum number of bidders for the event. During the event, the seller has access to see the number of bidders and the total amount of the bids. The seller may optionally allow the bidders to know of the seller's reserve price. In step 110, the seller selects the time limit for the event. If the time is selected to be too short, it is possible that the minimum number of bidders may not be satisfied for that event.

The rules relating to the type of income to be made by the seller, by the winner, and/or by the bidders are selected in step 112. The seller income is made by the sum of all non-winning bids that are given to the seller after deducting some fees (as for example: host fees (eGainers), etc). The winner gets the product for free as his bid is reimbursed by the host.

At any time during the rules-setting process, the seller can alter any of the rules. Therefore, the order that is depicted in FIG. 1 and described herein is meant merely to be exemplary and can be changed in any way, as indicated by the arrows to the left in FIG. 1. The event begins in step 114 and is carried out until it is completed, in step 116, either with a successful transaction or a cancellation of the transaction. The seller can, in step 118, set up new events and can be prompted automatically, for example, to set up a new event after each event

An example event can be the sale of a used cell phone. The seller determines that he/she can sell the phone for $100 to particular buyers or that this price is the going rate for that phone. However, the seller decides that this minimum price ($100) is not desirable as a reserve price, but he wants to have a symbolic reserve price of only $1. Instead, the seller wants to have the number of bids determine the desired sales price between different options given by the website. This means that the seller determines that at least three bidders are necessary for the event, in other words, the event can automatically begin after three bidders have placed their bids.

The seller can set the minimum bid amount to be $3. This means that, when the event starts, the seller would be guaranteed to gain at least $6 for the event—this total arising from a three-bidder event with the winner receiving a refund of the entire $3 bid for this event. From this minimum total of $6 to the seller, eGainers receives a particular percentage, which can be any amount but, in this example, is 10%. This means that, for this event, eGainers will receive at least $0.60 and the seller will receive, at a minimum, $5.40.

However, if the number of bidders in this example, actually is one-hundred, then more sales profits are generated. In particular, the total the seller will receive is $297 minus the 10% fee of $29.70, which equals a sales price of $267.3 for an item that the seller would have received $100 if that seller sold the item at market value.

### Server

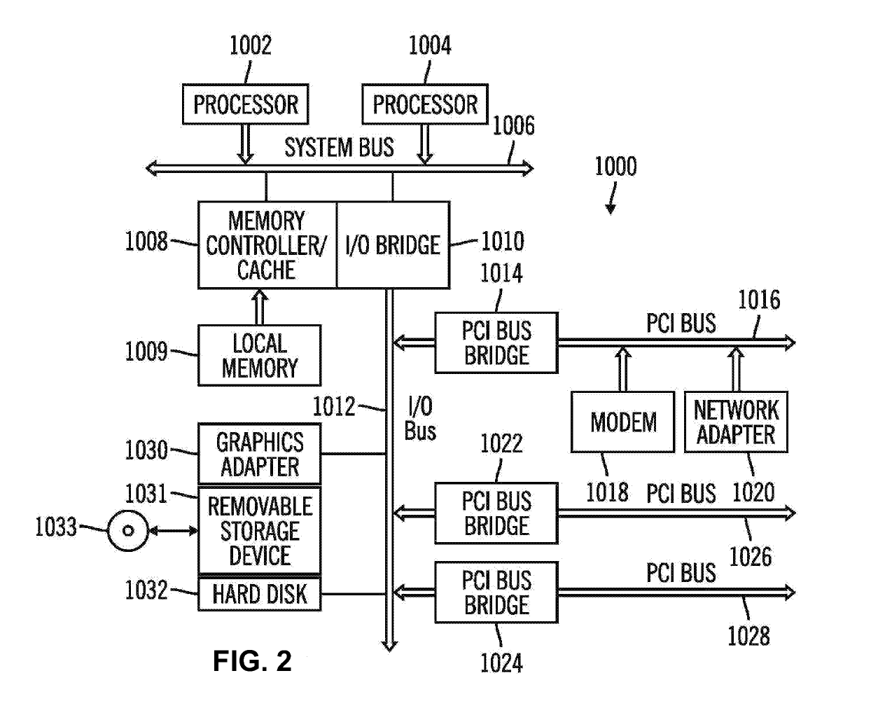

Referring to FIG. 2, a block diagram of one exemplary embodiment of a system for hosting the bidding system of the invention, which system may be implemented as a server connected to the Internet. Data processing system 1000 may be a symmetric multiprocessor (SMP) system including a plurality of processors 1002 and 1004 connected to system bus 1006. Alternatively, a single processor system may be employed. Also, connected to system bus 1006 is memory controller/cache 1008, which provides an interface to local memory 1009. I/O bus bridge 1010 is connected to system bus 1006 and provides an interface to I/O bus 1012. Memory controller/cache 1008 and I/O bus bridge 1010 may be integrated as depicted. The processor 1002 or 1004 in conjunction with memory controller 1008 controls what data is stored in memory 1009. The processor 1002 or 1004 can also work in conjunction with any other memory device or storage locations to serve as a monitor for monitoring data being stored and/or accessed on the data storage areas.

Peripheral component interconnect (PCI) bus bridge 1014 connected to I/O bus 1012 provides an interface to PCI local bus 1016. A number of modems may be connected to PCI bus 1016. Typical PCI bus implementations will support four PCI expansion slots or add-in connectors. Communications links to network computers may be provided through modem 1018 and network adapter 1020 connected to PCI local bus 1016 through add-in boards.

Additional PCI bus bridges 1022 and 1024 provide interfaces for additional PCI buses 1026 and 1028, from which additional modems or network adapters may be supported. In this manner, data processing system 1000 allows connections to multiple network computers. A memory-mapped graphics adapter 1030 and hard disk 1032 may also be connected to I/O bus 1012 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

In this document, the terms “computer program medium,” “computer usable medium,” and “computer readable medium” are used to generally refer to media such as main memory 1009, removable storage drive 1031, removable media 1033, hard disk 1032, and signals. These computer program products are measures for providing software to the computer system. The computer readable medium allows the computer system to read data, instructions, messages, or message packets and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may include computer readable information in a transitory state medium such as a network link and/or a network interface, including a wired network or a wireless network, which allow a computer to read such computer readable information.

Computer programs (also referred to as computer control logic) are stored in memory. Computer programs may also be received via communications interface 1016. Such computer programs, when executed, enable the computer system to perform the features of the present invention as discussed herein. In particular, the computer programs, when executed, enable the processor 1002 and/or 1004 to perform the features of the computer system. Accordingly, such computer programs represent controllers of the computer system.

### Seller/Bidder Device

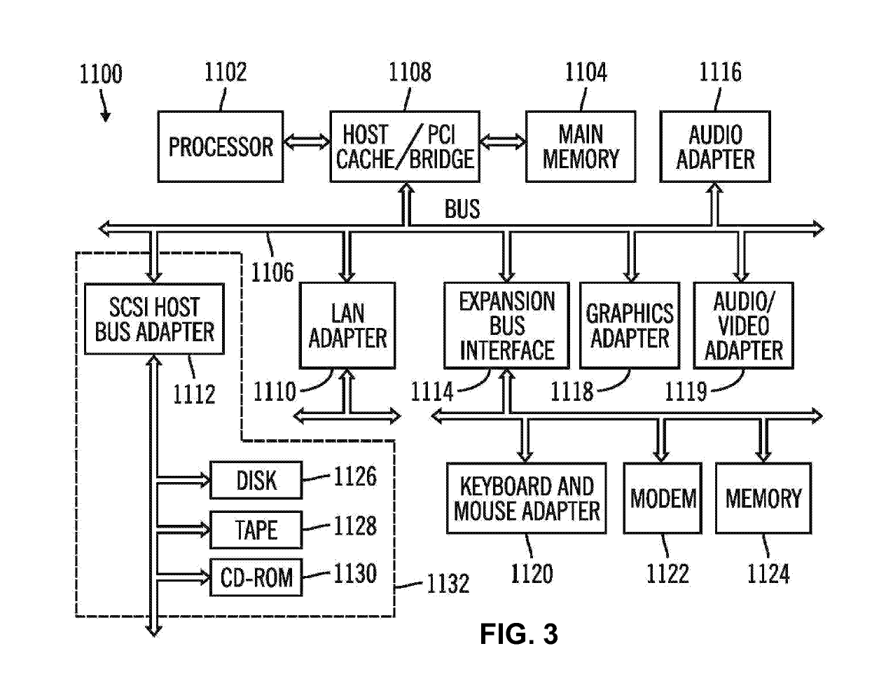

With reference now to FIG. 3, a block diagram of one exemplary embodiment of a data processing system 1100 on which the present invention may be implemented by a user of the invention. In particular, data processing system 1100 is an example of a computer, e.g., communication device, used by a seller or a bidder. Data processing system 1100 employs a peripheral component interconnect (PCI) local bus architecture. Although the depicted example employs a PCI bus, other bus architectures such as Accelerated Graphics Port (AGP) and Industry Standard Architecture (ISA) may be used. Processor 1102 and main memory 1104 are connected to PCI local bus 1106 through PCI bridge 1108. PCI bridge 1108 also may include an integrated memory controller and cache memory for processor 1102. Additional connections to PCI local bus 1106 may be made through direct component interconnection or through add-in boards. In the depicted example, local area network (LAN) adapter 1110, SCSI host bus adapter 1112, and expansion bus interface 1114 are connected to PCI local bus 1106 by direct component connection. In contrast, audio adapter 1116, graphics adapter 1118, and audio/video adapter 1119 are connected to PCI local bus 1106 by add-in boards inserted into expansion slots. Expansion bus interface 1114 provides a connection for a keyboard and mouse adapter 1120, modem 1122, and additional memory 1124, for example. Small computer system interface (SCSI) host bus adapter 1112 provides a connection for hard disk drive 1126, tape drive 1128, and CD-ROM drive 1130, for example. Typical PCI local bus implementations will support three or four PCI expansion slots or add-in connectors.

An operating system runs on processor 1102 and is used to coordinate and provide control of various components within data processing system 1100 in FIG. 3. Each user is able to execute a different operating system. The operating system may be a commercially available operating system, such as WINDOWS®, which is available from Microsoft Corporation. A database program such as ORACLE® may run in conjunction with the operating system and provide calls to the operating system from JAVA® programs or applications executing on data processing system 1100. Instructions for the operating system, the object-oriented operating system, and applications or programs are located on storage devices, such as hard disk drive 1126, and may be loaded into main memory 1104 for execution by processor 1102.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 1100 may be a stand-alone system configured to be bootable without relying on some type of network communication interface, whether or not data processing system 1100 includes some type of network communication interface. As a further example, data processing system 1100 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 1100 also may be a notebook computer or hand-held computer in addition to taking the form of a PDA. Data processing system 1100 also may be a kiosk or a Web appliance.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for selling items using a host, which comprises:
creating an event for an item to be sold by a seller;
configuring the event as a virtual envelope;
setting rules for the event, the rules comprising:
a reserve amount;
bidding rules;
bidder rules;
a time limit; and
seller profit rules;
allowing bidders to post on the virtual envelope to make bids on the item; and
selling the item based on the rules for the event.

2. The method of claim 1, wherein the reserve amount is a minimum of a total of the bids made by all non-winning bidders.

3. The method of claim 1, wherein the bids are refundable.

4. The method of claim 1, wherein the bids are not refundable.

5. The method of claim 1, wherein the bids can be increased.

6. The method of claim 1, wherein the seller selects one or both of a minimum and a maximum number of bidders for the event.

7. The method of claim 1, which further comprises carrying out the rules setting step by having the seller allow the bidders to know the reserve amount.

8. The method of claim 1, which further comprising permitting the seller to see at least one of a number of bidders and a total amount of bids.

9. The method of claim 1, which further comprising permitting lower, already purchased bids to be used as a credit toward higher-costing bids.

10. The method of claim 1, which further comprising receiving the bids over the Internet.

11. The method of claim 10, which further comprising receiving the bids through email.

12. The method of claim 10, which further comprising receiving the bids through an application on a communication device.

13. The method of claim 1, which further comprising receiving the bids from a communication device.

14. The method of claim 1, wherein the bids are deemed as at least one of non-refundable deposits and options to buy.

15. The method of claim 1, which further comprising carrying out the event to produce a winning bidder who wins the item and refunding to the winning bidder at least a portion of the winning bidder's bid.

16. The method of claim 15, which further comprises paying a bid amount not refunded to the winning bidder to the seller subject to a fee for the host.

17. The method of claim 1, which further comprises providing the seller with a right to cancel the event within rules for cancellation.

18. The method of claim 17, which further comprising refunding at least a portion of the bids to the bidders when the seller cancels the event.
